(19) United States
(12) Patent Application Publication
(10) Pub. No.: US 2006/0059554 A1
(43) Pub. Date: Mar. 16, 2006

(54) System and method for information technology intrusion prevention

(76) Inventor: Ofer Akerman, Jordan Valley (IL)

Correspondence Address: GOTTLIEB RACKMAN & REISMAN PC, 270 MADISON AVENUE, 8TH FLOOR, NEW YORK, NY, 100160601, US

(21) Appl. No.: 10/940,357

(22) Filed: Sep. 13, 2004

(51) Int. Cl. G06F 12/14

(52) U.S. Cl. 726/22

(57) ABSTRACT

An open architecture, transparent and expandable system for proactively preventing cyber-attacks into and within a communication network of a user organization. The system includes a plurality of modals in the form of abstract security objects. The modals are the expandable feature of the system that perform at least one of the following security operations: Internet protocols (IP's); context-based pattern matching; target quarantine; faking responses; defragmentation; monitoring; a virtual honeypot; and protocol analysis, wherein the modals perform different operations using different data. The system also includes: a plurality of bricks, wherein the bricks are specific implementations of the modals, such that a brick equals a modal plus data, and such that the bricks create a course of action that defines the inspection flow within a single policy and between policy chains; a plurality of policies, wherein the policies are chains of bricks that are executed by the system architecture, wherein the security manager of the user organization may define the profile on which the policy will be performed; an intelligence database for storing information about the attacks and the attackers; and a modal system development kit (SDK), wherein third party companies develop new modals according to the open architecture, and transparently integrate the new modals into the system.

### FIELD OF THE INVENTION

This invention relates to a system and method for the security of incoming information through a communication network, and in particular, a system and method for preventing intrusions that avoids making the wrong prevention decisions.

### BACKGROUND OF THE INVENTION

Intrusion prevention systems (IPS's) are the next generation of network security. Intrusion detection systems (IDS's) are an earlier generation that monitor network related events, but were not designed to prevent attacks. Each policy specifies the static target group, service, patterns, and set of operations. Most IDS technologies rely on single-policy detection with each policy acting as an independent decision maker: Forward or Block. Although this is good enough for detection, the real challenge of intrusion prevention lies in the handling of unclear situations, suspicious but not conclusively malicious traffic. Current security products are based on policies that are predefined by the security team. However, IPS's that are based on detection concepts and technology face the same arguments of inefficiency as IDS technologies.

To protect today's networks, enterprises have been relying on prevailing defensive solutions such as firewalls, AV software vulnerability scanners, and traditional Intrusion Detection Systems (IDS). However with the growth of cyber terrorism and increasingly sophisticated attacks, these security measures are deficient.

Many companies provide the functionality of tracing back the attackers IP and building statistical reports. Further more, many forensics investigators are taking the passive logs and running probing tools.

This process is based on dangerous assumptions:
Timing is everything. When was the information collected and on which targets? Most technologies today are gathering information about the attackers in office mode, i.e. running the tools while conducting the analysis/investigation. This action may lead to incorrect intelligence, which can cause incorrect decisions;
Information flooding: The outputs of these activities are usually only informative reports that have no practical value for increasing effective security; and
Interpretation is time consuming: what skills are needed to analyze this information and what is the gap between the analysis process and decision making for increasing security? Most corporations do not have these skills or resources in-house.

The goal is to increase affective security, not to generate superfluous informative reports.

Sixty-four percent of large corporations and government agencies have acknowledged financial losses stemming from computer security breaches, according to The Computer Security Institute/FBI “2004 Computer Crime and Security Survey:”
90 percent of respondents (primarily large corporations and government agencies) detected computer security breaches within the last 12 months;
64 percent acknowledged financial losses due to computer breaches;
As in previous years, the most serious financial losses occurred through theft of proprietary information (41 respondents reported $170,827,000) and financial fraud (40 respondents reported $115,753,000); and
For the fifth year in a row, more respondents (74 percent) cited their Internet connection as a frequent point of attack than cited their internal systems as a frequent point of attack (33 percent).

Inherent problems with IDS solutions include the inability to stop a suspected packet in real-time, a high number of false alarms, managability problems and high Total Cost of Ownership (TCO). In general, most information technology (IT) security systems are reactive.

Therefore, there is a need for a proactive IT security system that can prevent known and previously unknown forms of cyber-attack.

### SUMMARY OF THE INVENTION

Accordingly, it is a principal object of the present invention to provide a system and method that proactively protects information technology (IT) security systems.

It is a further object of the present invention to provide a system and method which can prevent known and previously unknown forms of cyber-attack.

It is another object of the present invention to provide profile-based policies that replace a static group with a dynamic profile, dynamically generating the rule group according to the state of security at any given moment.

It is yet another object of the present invention to modify the incoming data according to the state of security, so it is unnecessary to know in advance who the enemies are, thus focusing on suspicious packets or streams while minimizing the interaction with good traffic.

An open architecture, transparent and expandable system is disclosed for proactively preventing cyber-attacks into and within a communication network of a user organization. The system includes a plurality of modals in the form of abstract security objects. The modals are the expandable feature of the system that perform at least one of the following security operations: Internet protocols (IP's); context-based pattern matching; target quarantine; faking responses; defragmentation; monitoring; a virtual honeypot; and protocol analysis, wherein the modals perform different operations using different data. The system also includes: a plurality of bricks, wherein the bricks are specific implementations of the modals, such that a brick equals a modal plus data, and such that the bricks create a course of action that defines the inspection flow within a single policy and between policy chains; a plurality of policies, wherein the policies are chains of bricks that are executed by the system architecture, wherein the security manager of the user organization may define the profile on which the policy will be performed; an intelligence database for storing information about the attacks and the attackers; and a modal system development kit (SDK), wherein third party companies develop new modals according to the open architecture, and transparently integrate the new modals into the system.

Whereas, similar to human ‘bouncers’ who decide who is allowed entry and who is not, the intrusion prevention systems (IPS's) of the present invention is a proactive solution that blocks harmful network traffic while forwarding the rest. The Bouncer™ solution provides a Target Activity Inspection Matrix (TAIM) that follows target traffic until it verifies that it is harmless. This procedure ensures a low rate of false positives with a minimal affect on normal traffic.

The Bouncer™ architecture is based on three major elements: Modals, Bricks and Policies.

Modals are abstract objects that aim to perform a variety of security operations: (examples are selecting Internet protocols (IP's), choosing patterns, faking responses, de-fragmentation, monitoring, protocol analysis, etc.). The modal contains operational methods, but it does not embed security data. In fact, the modal itself is used to perform different operations with using different data and parameters. Modals can be dynamically added or update with no reinstallation or stopping of the Bouncer™.

Bricks are specific implementations of the modals (BRICK=MODAL+DATA). Bricks are the building blocks of the bouncer security policy. Brick's data can be modified on the fly by ACC's. Bricks, like modals, can be added, updated and distributed without any re-installation or interruption of the activity of the Bouncer™. Bricks support a variety of inputs and, based upon its embedded modal, they create the course of action. This course of action defines the inspection flow within a single policy and between policy chains.

Policies are chains of bricks that are executed by the bouncer engine. Bouncer™ policies are dynamic. The target group may not be defined while creating the policy. Instead, the security manager may define the profile on which the policy will be performed. Policies are executed according to their priority and level of inspection. The Bouncer™ provides a visual execution plan so that the security manager can see in advance which operations the Bouncer™ has performed, given a particular scenario. This feature alone provides considerable information that helps to increase inspection effectiveness.

Policies, like Bricks can be added, updated and distributed without any re-installation or interruption of the Bouncer™. This feature helps consolidation management and with building unified security policies that can be distributed to all protected locations.

Adaptive Contexts Containers (ACC's) are created on the fly and contain cross policy groups. Examples of ACC's are a list of most active attackers with the same profile, most attacking ISP, source of attack countries, etc. These contexts may be use as dynamic selectors for any of the Bouncer™ Bricks. Contexts are based on the Target Activity Inspection Matrix (TAIM). An example of an ACC is Target Quarantine.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic block diagram of the brick method of operation, according to the principles of the present invention;

FIG. 2 is a schematic block diagram showing how policies are chains of bricks that are executed by the BDU engine, according to the principles of the present invention;

FIG. 3 is an example of an adaptive context container for target quarantine, according to the principles of the present invention;

FIG. 4 is a screen shot of some of the modals provided with the default Bouncer™ package, according to the principles of the present invention;

FIG. 5 is a screen shot of an exemplary default brick GUI, wherein the modal data is set, according to the principles of the present invention;

FIG. 6 is an exemplary block diagram of policy chains, according to the principles of the present invention;

FIG. 7 is an exemplary block diagram which illustrates the flow from bricks, policy and intelligence gathering, according to the principles of the present invention;

FIG. 8 is an exemplary block diagram which illustrates the Target Activity Inspection Matrix (TAIM) that follows target traffic until it verifies that it is harmless, according to the principles of the present invention;

FIG. 9 is an exemplary chart, which illustrates the TAIM monitoring and operation desk 900, according to the principles of the present invention;

FIG. 10 is an exemplary screen shot, which includes an advance logging modal, which provides more details about the security situation, according to the principles of the present invention;

FIG. 11 is a screen shot of the policy distribution, which allows the security manager to change certain log settings, such as log size and percentage, according to the principles of the present invention; and

FIG. 12 is an exemplary screen shot of the Bouncer™ interface, which helps the security manager to understand what is happening at any given moment and why, according to the principles of the present invention.

### DETAILED DESCRIPTION OF A PREFERRED EMBODIMENT

The principles and operation of a method and an apparatus according to the present invention may be better understood with reference to the drawings and the accompanying description, it being understood that these drawings are given for illustrative purposes only and are not meant to be limiting.

The present invention provides a Target Activity Inspection Matrix (TAIM) that follows target traffic until it verifies that it is harmless. This procedure ensures a low rate of false positives with a minimal effect on normal traffic. The present invention includes the following components:
Bouncer Defense Unit (BDU)
Bouncer Control Unit (BCU)
Bouncer Reporting Unit
Intelligence Plug-In
Alarm Center Plug-In
Bouncer Shield Plug-in
Update Manager Plug-In
Bouncer Inter-connection Channel (BIC)

The BDU is the core of the intrusion prevention system. Its defined policies determine the level of prevention protection. The BDU is absolutely transparent, it does not affect network traffic and it can be deployed in different methods. It can also be placed on multiple network segments, such as the perimeter, DMZ, etc. The BDU can be set up using the default set of policies or deployed after customizing the policies according to the customer's requirements.

The BCU is an intuitive and easy-to-use control center. By selecting a BDU from the console, the security operator can do set up, monitor traffic and query logs for all the BDU's in the system. All the communication between the Bouncer™ and the BCU is through transparent protocol (not TCP/IP), so as to maximize end-to-end security.

Modals are abstract objects aimed at performing a variety of security operations such as selecting IP packets, choosing patterns, faking responses, defragmentation, monitoring, protocol analysis and so forth. Modals contain operational methods, but do not embed security data. In fact, the modal itself is used to perform different operations with using different data and different parameters. A modal can be dynamically updated without reinstalling or stopping the BDU. Bricks are specific implementations of the modals. A brick=a modal+data.

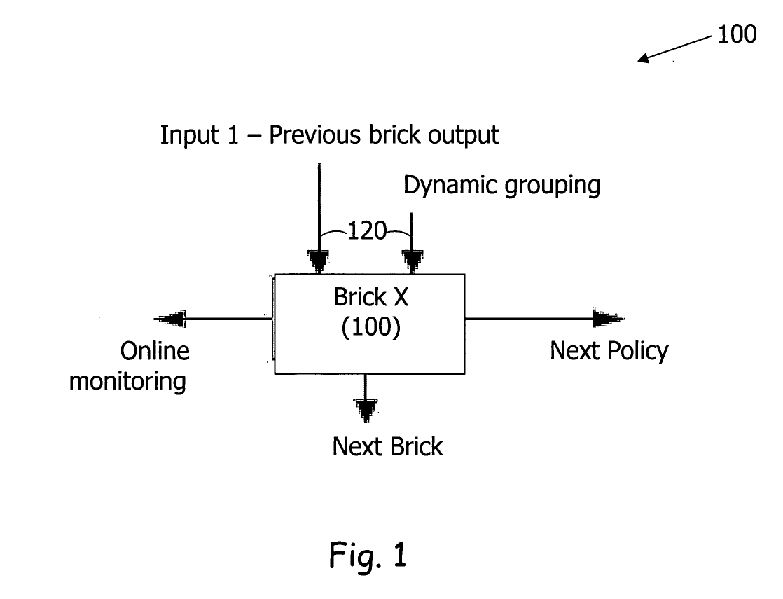

FIG. 1 is a schematic block diagram of the brick method of operation 100, according to the principles of the present invention. Bricks 110 are the building blocks of the Bouncer™ security policy. Brick data can be modified automatically, on the fly, with information gathered in real-time. Bricks 110, like modals, can be added, updated and distributed without reinstalling or stopping the Bouncer™ activity. As shown in FIG. 1, bricks 110 support a variety of inputs 120. Brick 110 will choose a course of action according to its embedded modal. This course of action defines the inspection flow within a single policy and between policy chains.

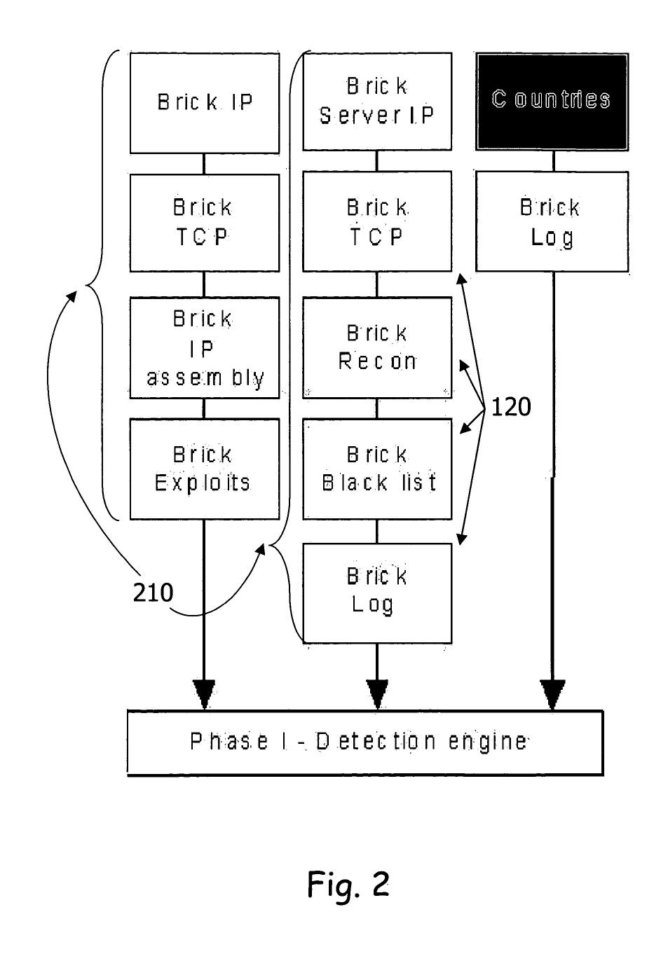

FIG. 2 is a schematic block diagram showing how policies 210 are chains of bricks 110 that are executed by the BDU engine, according to the principles of the present invention. When a policy is defined, one can set up an inspection and operation flow composed of predefined bricks. Different inspection policy types use different types of bricks:
Packet-level inspection policies
Protocol-level inspection policies
Application-level inspection policies
Bandwidth-level inspection policies
Reconnaissance policies

One can add logging capabilities to a policy by adding logging bricks. Bouncer™ policies are dynamic and can be created before the target group is defined. The Security Manager can then define an operative profile for that particular policy.

Policies are executed according to their priority and level of inspection. The Bouncer™ provides a visual display of the execution plan so the security manager knows in advance the chain of operations involved in each scenario. This feature provides a wealth of information that increases the effectiveness of the inspection process. Policies, like bricks, can be added to, updated and distributed without reinstalling or stopping Bouncer™ activity. This option consolidates management and helps create unified security policies, which are distributed to all protected locations.

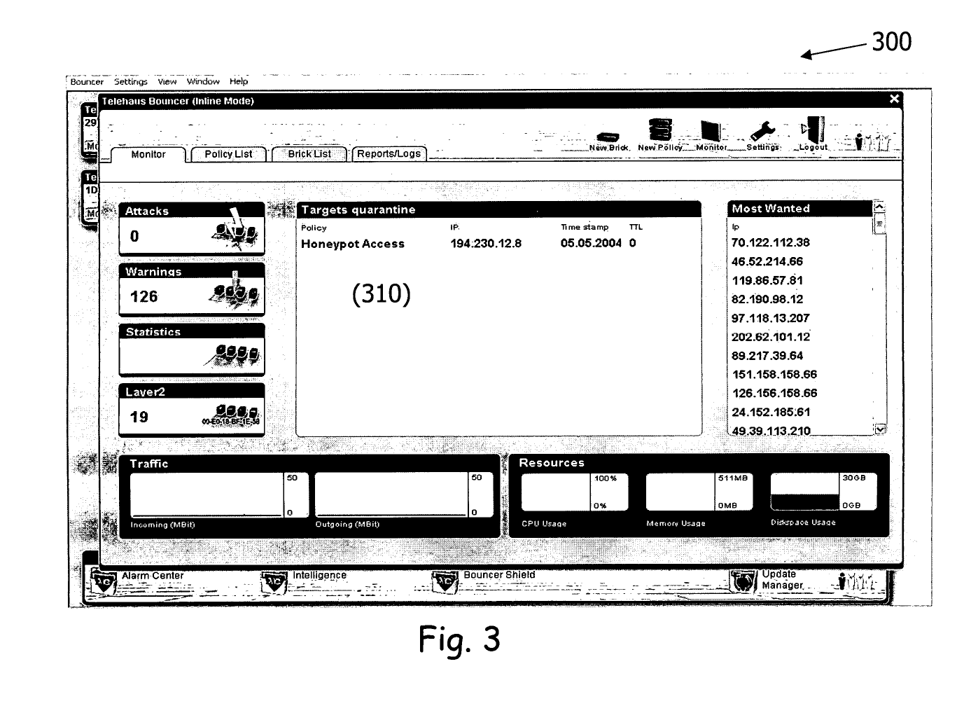

FIG. 3 is an example of an Adaptive Context Container 300 for target quarantine 310, according to the principles of the present invention. Adaptive Contexts Containers (ACC's) are created online. They contain cross policy groups for example, a list of the most active attackers with the same profile. These contexts may be used as dynamic selectors for any of the Bouncer™ bricks. ACC's may be distributed or even created in a central location providing cross-site intelligence gathering. ACC's are saved in history logs. The Bouncer™ provides drilldown and cross-reference methods that enable target tracing activity.

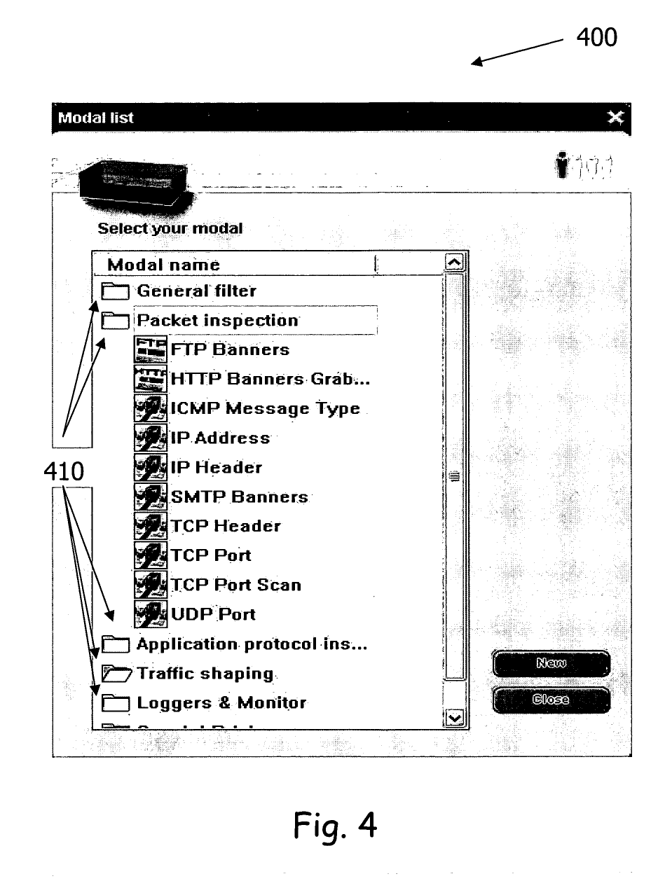

FIG. 4 is a screen shot of some of the modals provided with the default Bouncer™ package 400, according to the principles of the present invention. The modals application program interfaces (API's) are open and allow third party companies to develop their own security measures. Each modal 410 is provided with a default graphical user interface (GUI) representation. The control unit of the present invention uses these representations to display a unified form to the user. The brick example in FIG. 4 is for modal data setting.

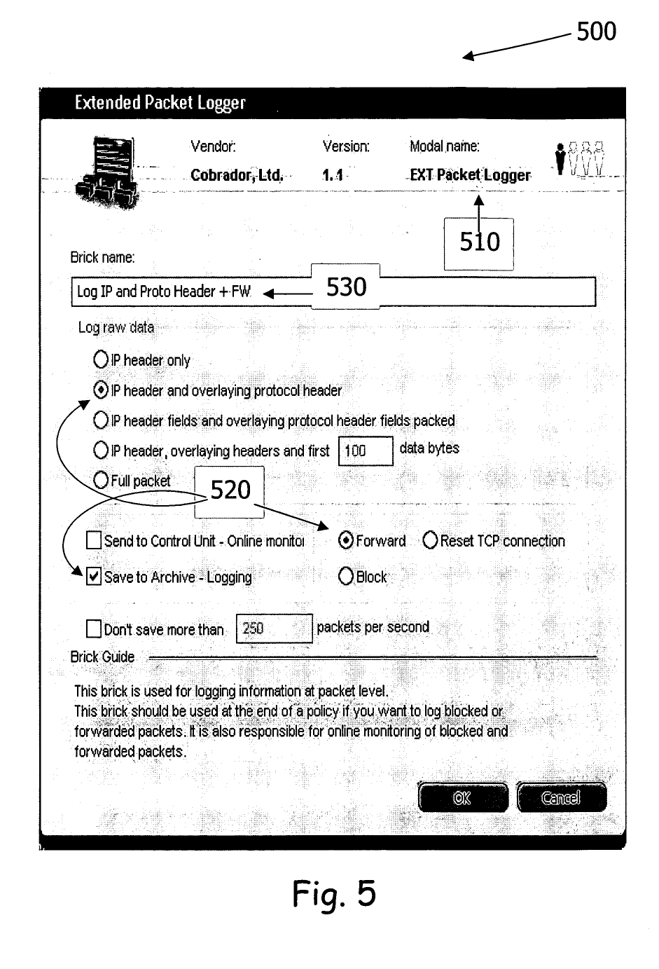

FIG. 5 is a screen shot of an exemplary default brick GUI 500, wherein the modal data is set, according to the principles of the present invention. After setting the parameters with the required data 520, the modal 510 is saved as a brick 530. There is a “one-to-one” relationship between modals and bricks.

The architecture of the present invention introduces a unique hybridization of security measures. The following measures were chosen to illustrate the new approach for practical security:
profile based policy;
preventive intelligence;
TAIM-Targets Activity Inspection Matrix; and
flexible logging system.

The idea behind the profile based policy of the present invention is to replace a static policy group with a dynamic profile, which can generate a rule group on the fly, according to the state of security at a given moment.

The following are a few examples of profile based policies:
limit bandwidth usage for all targets suspected of performing port scanning;
block all targets dependent upon policy criteria, if they raise events highlighted in previous policies during a specified timeframe;
activate additional file transfer protocol (FTP) policies only on targets that generate more than 3 errors within one session;
provide monitor display only for attacks that have successfully accomplished the 3-way handshake (3WHS); and
activate anti-Distributed Denial of Service (DDOS) brick on Internet service provider (ISP) level 1 for top scanners.

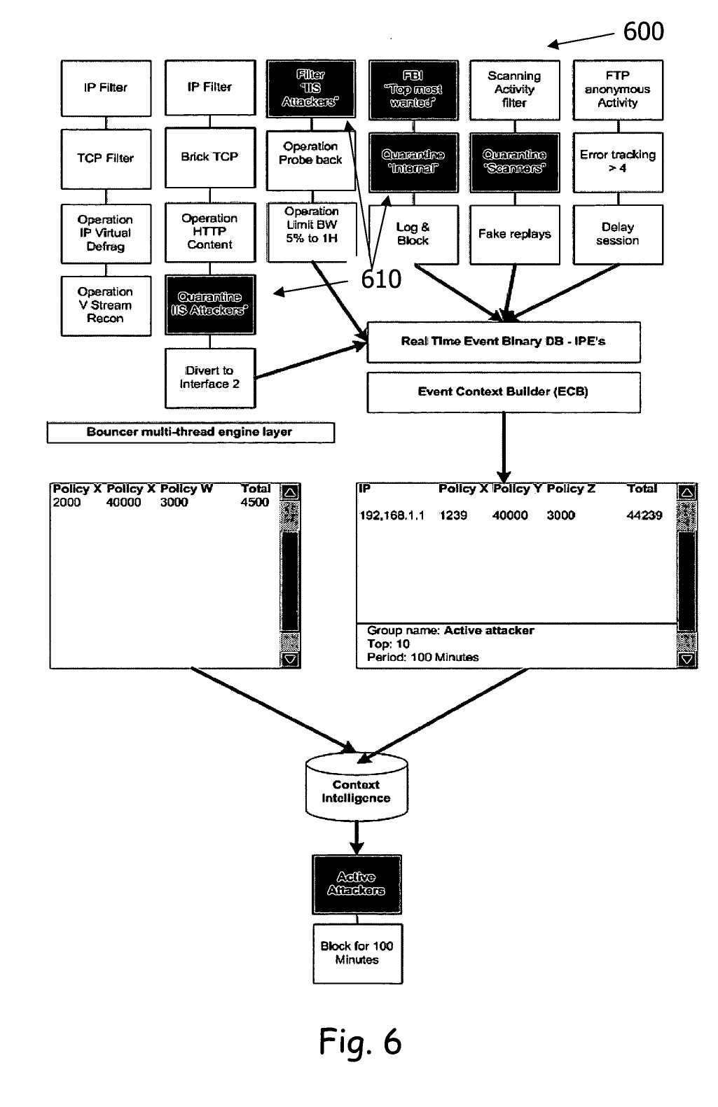

FIG. 6 is an exemplary block diagram of policy chains 600, according to the principles of the present invention. Bouncer™ polices are a chain of bricks. These bricks contain data. The bouncer is capable of modifying the data dynamically dependant on the state of the security, so one does not have to know in advance who the enemies are. The bricks with the grey background 610 contain data which is created dynamically. This allows the present invention to focus on suspicious groups, while minimizing the interaction with “clean” traffic.

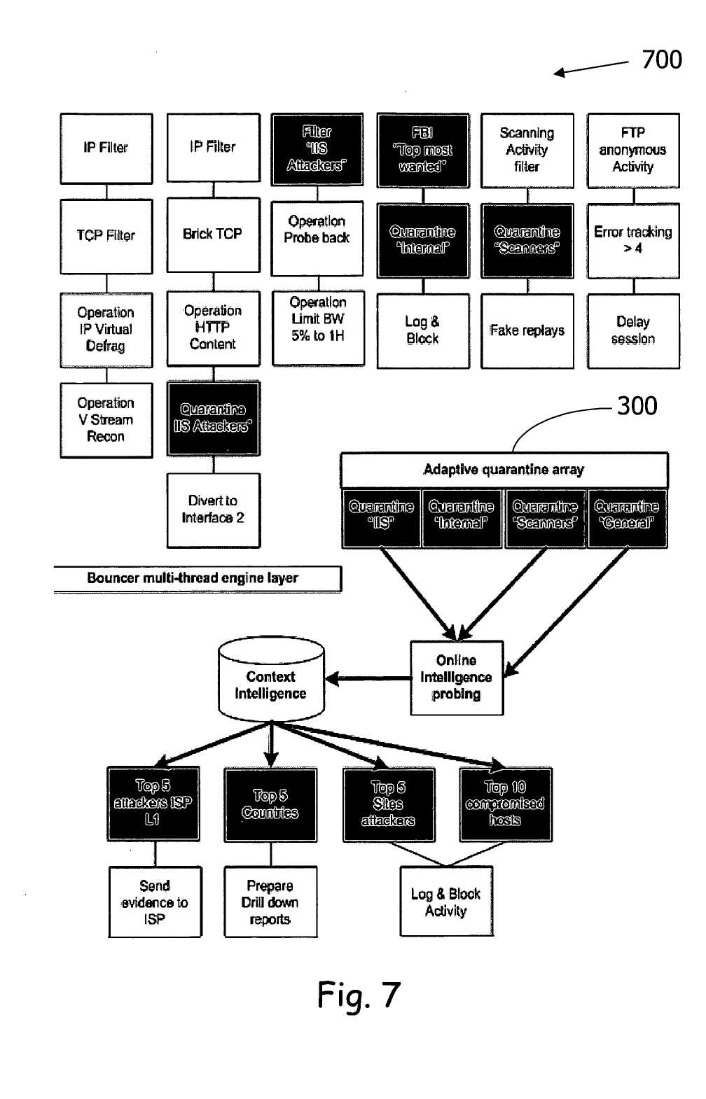

FIG. 7 is an exemplary block diagram which illustrates the flow from bricks, policy and intelligence gathering on specific profiles 700, according to the principles of the present invention. This information is passed to the ACC's 300 and creates a dynamic group that can be used within the brick. Preventive intelligence provided by the present invention is concerned with gathering target related information and based on that information, generating preventive contexts.

The preventive intelligence concept has the following features:
a powerful blocking strategy: The first intuitive action after identifying an attacker is to block them. While this argument is fundamentally true, by doing so one may lose the best window of opportunity to gather real intelligence about the enemy. Bouncer™ implements recursive tunneling methods in order to delay the attacker until the intelligence gathering is complete, without letting them know for certain that they have been blocked. This data is stored on the intelligence database. In contrast to offline gathering, this intelligence is very accurate as it collected while the attacker is in action;
robust filtering: avoid spoofing and flooding by using the TAIM and advance filtering, e.g., collecting intelligence only on an attacker that has accomplished the 3WHS process;
building intelligence context containers: these containers may be monitored and logged. With drill down capabilities they help with analysis and investigations. Examples of these containers are: most attacking ISP L1, L2; most attacking countries; most attacking nodes; and most attacking sites/type of attack. These contexts may be distributed; and
tunnel these containers as bricks back to the prevention engine.

Usage examples:
limit the bandwidth of 5 noisy ISP's which are not from the USA. (count only attacks after 3WHS);
limit access to specific servers from specific countries during specific times at the origin; and
limit the number of permitted connections during night hours from the most noisy countries.

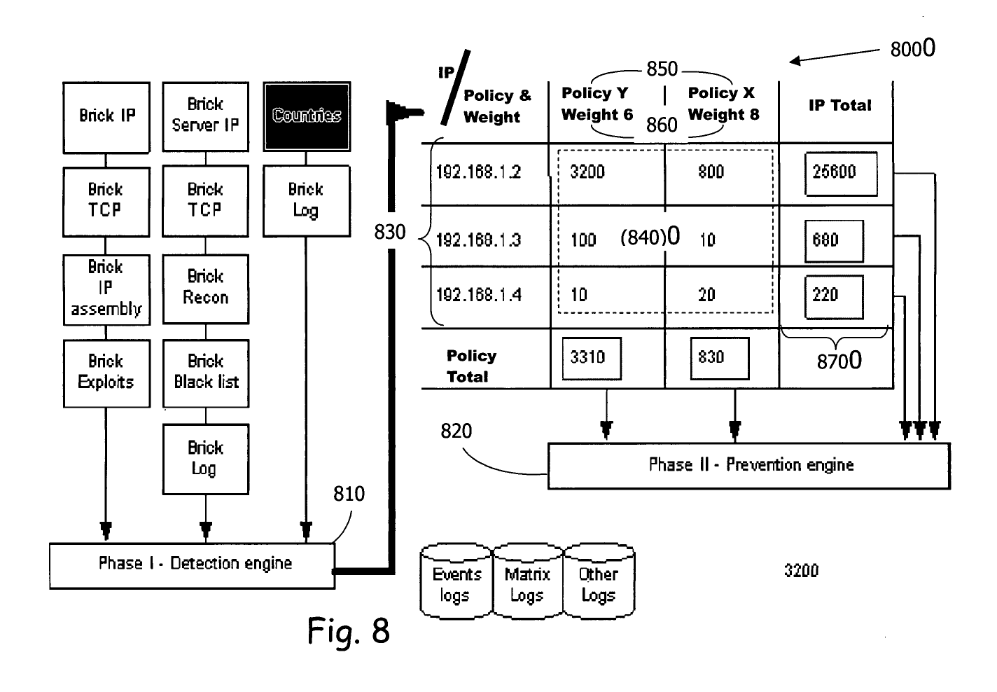

FIG. 8 is an exemplary block diagram which illustrates the Target Activity Inspection Matrix (TAIM) 800 that follows target traffic until it verifies that it is harmless, according to the principles of the present invention. TAIM 800 illustrates the relationship between the phase I detection engine 810 and the phase II prevention engine 820. The procedure ensures a low rate of false positives with a minimal effect on normal traffic.

TAIM 800 supports attack prevention while avoiding false positives. The basic concept is building a dynamic matrix that follows cross-policy target activity with reference to global contexts (intelligence). For various Internet Protocol (IP) addresses 830, the number of invocations 840 of each policy 850 are multiplied by respective weights 860 to calculate totals 870 for each IP address 830. The matrix is used as the basis for network traffic filtering. TAIM 800 preventive decisions are based on making a cross-reference to the attack profile instead of using flat detection (single policy detection). This is done in two steps:

The first step involves building the matrix.

The second step involves making a preventive decision based on this matrix.

From a usability point of view, the TAIM introduces a new generation of practical monitoring. By showing the attack flow itself, instead of many events, the security manager gains a better understanding of the security state at any given moment. Instead of making offline event correlations, this process provides the ability to monitor and act in real time.

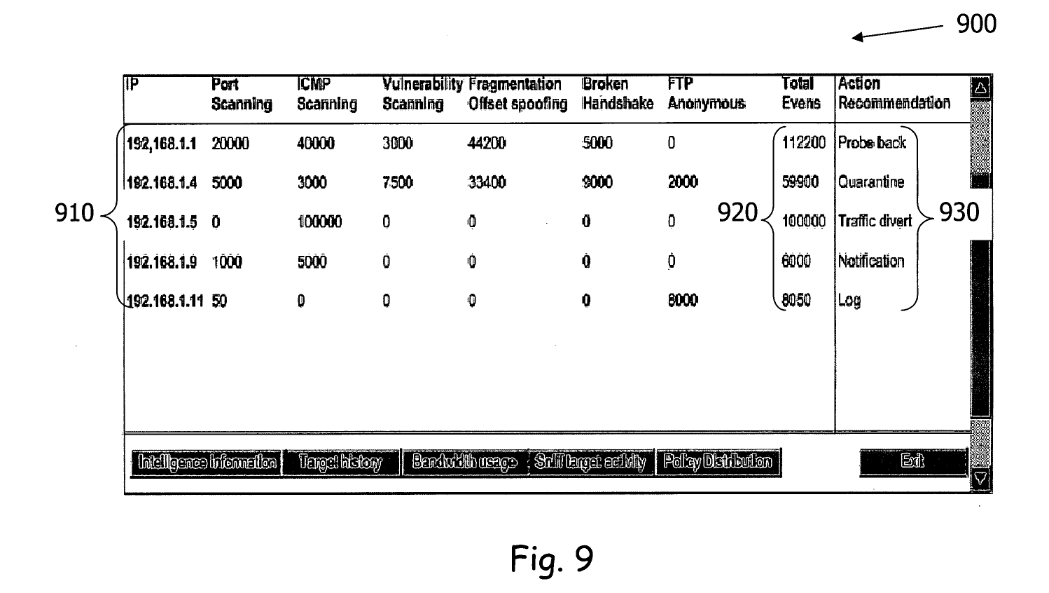

FIG. 9 is an exemplary chart, which illustrates the TAIM monitoring and operation desk 900, according to the principles of the present invention. For various IP addresses 910, the number of occurrences of various events 920 are accumulated and an action is recommended 930 for each IP address 910.

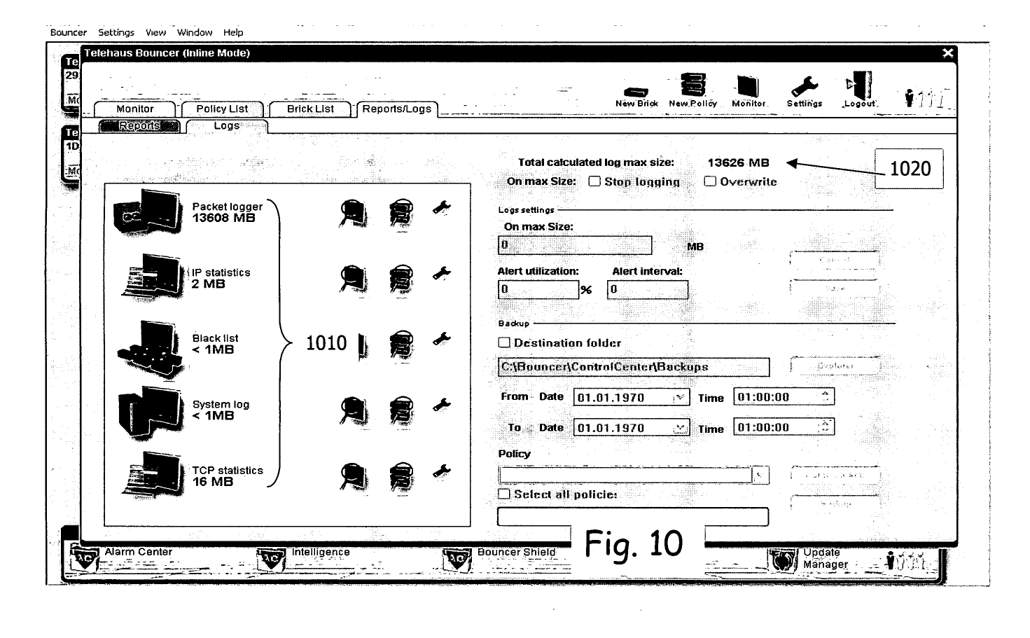

FIG. 10 is an exemplary screen shot, which includes an advance logging modal 1000, which provides more details about the security situation, according to the principles of the present invention. Flexible logs management, efficient logging mechanisms and advance retrieving capabilities are important to increase effective security and maintenance of digital evidence. The distribution of log sizes 1010 and the total calculated log max size 1020 is shown.

The logging system of the present invention is based on modals and bricks. The architecture includes an advance logging modal to allow a better understanding of the situation. Using modals and bricks provides features which include:
online monitoring of the distribution of the logs, i.e., the percentage of each policy within a given log, and the alarms on exceptions;
receiving operational advice regarding suspicious policy configuration;
supporting evidence gathering, e.g., logging of anonymous activity instead of logging only the last packet that has formed the suspicious pattern;
online correlation of streams and packets, the security manager gets the real scenario;
tracking deleted policies within the logs in order to preserve the evidence;
log distribution and redundancy, i.e., support of multiple mechanisms at different locations and according to dynamic rules; and
anti-flooding mechanisms, such as limiting the amount of log entry per target per policy or limiting the log entry of a policy that handles traffic before completion of 3WHS process. When logs get full, the bouncer provides overwrite option.

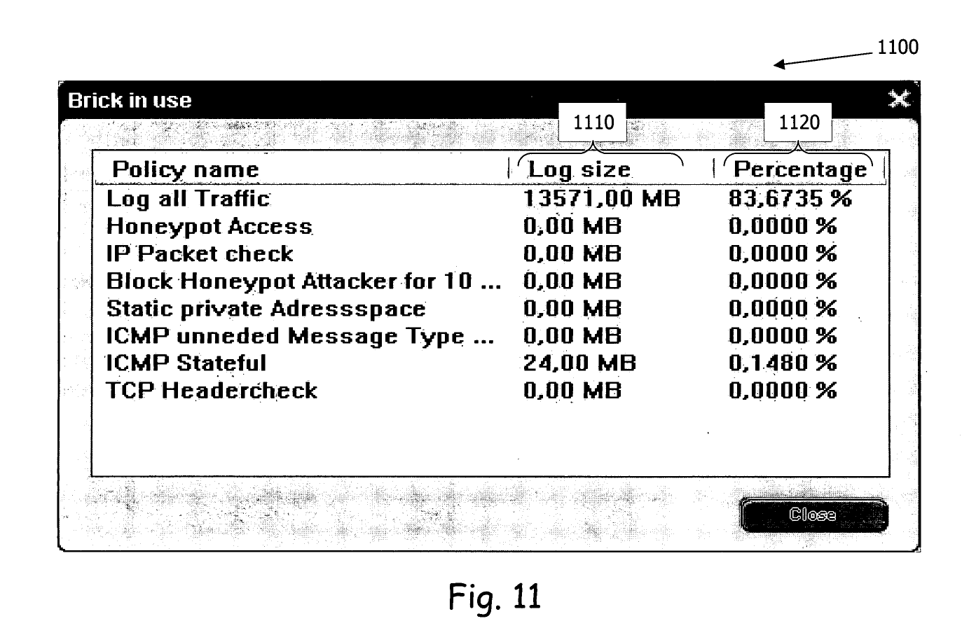

FIG. 11 is a screen shot of the online policy distribution, within a given log, which allows the security manager to change certain log settings, such as log size 1110 and percentage 1120, according to the principles of the present invention. Log settings can be changed “on the fly,” depending on the log profile. The present invention supports many types of logs and it permits different settings for each type. A best practice scenario would be to set the overwrite option of logs of pre-3WHS policies or out of stream connections. Each site should then define which type of evidence has highest priority for storage when system is under a massive attack.

The Bouncer™ Control Unit (BCU) provides easy to use and intuitive interfaces. From the menus, the security can control and actively monitor everything that is happening at any given moment. The Bouncer™ interface helps the security manager to understand what is happening at any giving moment and why.

For example:
who is currently working on the FTP server (by viewing streams in real-time);
from which countries are the attacks emanating;
who is consuming most of the bandwidth, and for which services; and
show the blocking distribution, i.e., which policy is generating the most events at any given moment, etc.

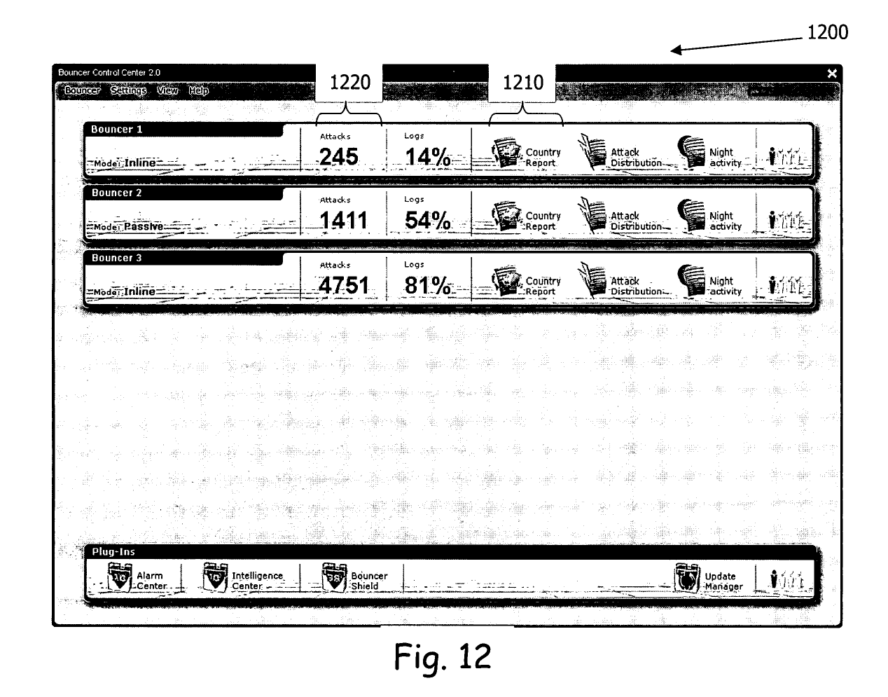

FIG. 12 is an exemplary screen shot of the Bouncer™ interface 1200, which helps the security manager to understand what is happening at any given moment and why, according to the principles of the present invention. E.g., who is currently working on the file transfer protocol (FTP) server, wherein services may be made available without any kind of authentication. The FTP server views streams in real-time, and the manager can see the country of origin 1210, who is consuming most of the bandwidth and for which services. Bouncer™ interface 1200 also shows the blocking distribution, i.e., which policy is generating most of the attacks 1220 at any given time.

It is to be understood that the phraseology and terminology employed herein are for the purpose of description, and should not be regarded as limiting.

It is important, therefore, that the scope of the invention is not construed as being limited by the illustrative embodiments set forth herein. Other variations are possible within the scope of the present invention as defined in the appended claims and their equivalents.

1. An open architecture, transparent and expandable system for proactively preventing cyber-attacks into and within a communication network of a user organization, said system comprising:
a plurality of modals in the form of abstract security objects, said modals being said expandable feature of said system that perform at least one of the following security operations:
Internet protocols (IP's);
context-based pattern matching;
target quarantine;
faking responses;
defragmentation;
monitoring;
a virtual honeypot; and
protocol analysis,
wherein said plurality of modal performs different operations using different data;
a plurality of bricks, wherein said bricks are specific implementations of said modals, such that a brick equals a modal plus data;
a plurality of policies forming chains of said bricks that are executed by the system architecture, wherein the security manager of said user organization may define the profile on which at least one of said policies will be performed, and wherein said plurality of bricks create a course of action that defines the inspection flow within a single policy and between policy chains;
an intelligence database for storing information about said attacks and the attackers; and
a modal system development kit (SDK),
wherein third party companies develop new modals according to said open architecture, and transparently integrate said new modals into said system.

2. The system according to claim 1, wherein said system avoids making the wrong decisions.

3. The system according to claim 1, further comprising a plurality of Adaptive Contexts Containers (ACC's) that are created on the fly, and contain cross policy groups, said ACC's comprising at least one of:
a list of most active attackers with the same profile;
the identity of the Internet Service Provider that is associated with the greatest number of attacks; and
a list of countries that are the most frequent source of attacks,
wherein contexts are based on a Target Activity Inspection Matrix (TAIM).

4. The system according to claim 1, wherein said system ensures a low rate of false positives with a minimal affect on normal traffic.

5. The system according to claim 1, wherein each of said plurality of modals can be dynamically added, updated and distributed without any re-installation and without interruption.

6. The system according to claim 1, wherein each of said plurality of bricks can be dynamically added, updated and distributed without any re-installation and without interruption.

7. The system according to claim 1, wherein each of said plurality of policies can be dynamically added, updated and distributed without any re-installation and without interruption, thereby helping to build unified security policies that can be distributed to all protected locations.

8. The system according to claim 1, wherein each of said plurality of policies are executed according to their priority and level of inspection.

9. The system according to claim 1, wherein said system architecture provides a visual execution plan so that the security manager of said user organization can see in advance which operations the system has performed.

10. The system according to claim 1, wherein said contexts may be used as dynamic selectors for any of said plurality of bricks.

11. A method according to the system of claim 1, for proactively providing security for information coming into a communication network of a user organization, wherein said system prevents intrusions, said method comprising:
implementing a powerful blocking strategy, wherein the first intuitive action after identifying an attacker is to block them, without losing the best window of opportunity to gather real intelligence data about said attacker;
implementing recursive tunneling methods in order to delay said attacker until said intelligence data gathering is complete, without letting said attacker know for certain that they have been blocked, and wherein said data is stored on said intelligence database;
robust filtering of said information by avoiding spoofing and flooding by using said TAIM in conjunction with advance filtering;
building intelligence context containers, wherein these containers may be monitored and logged, such that said containers comprise at least one of:
ISP L1, L2 associated with the most attacks;
countries associated with the most attacks;
nodes associated with the most attacks; and
sites associated with the most attacks for each type of attack; and
tunneling these containers as bricks back to the system architecture.

12. The method according to claim 10, wherein said containers are provided with drill down capabilities in order to help with analysis and investigations.

13. The method according to claim 10, wherein said profile based policies comprise at least one of the following steps:
limiting bandwidth usage for all targets suspected of performing port scanning;
blocking all targets dependent upon policy criteria, if they raise events highlighted in previous policies during a specified timeframe;
activating additional file transfer protocol (FTP) policies only on targets that generate more than a specified number of errors within one session;
providing monitor display for attacks that have successfully accomplished the 3-way handshake (3WHS); and
activating anti-Distributed Denial of Service (DDOS) brick on Internet service provider (ISP) level 1 for top scanners.
